(19) United States
(12) Patent Application Publication
(10) Pub. No.: US 2008/0228619 A1
(43) Pub. Date: Sep. 18, 2008

(54) APPARATUS, SYSTEM, AND METHOD FOR ALLOCATING SERVICE REQUESTS

(76) Inventors: Howard J. Locker, Cary, NC (US); Richard Wayne Cheston, Morrisville, NC (US); Daryl C. Cromer, Cary, NC (US); Randall Scott Springfield, Chapel Hill, NC (US); Michael Terrell Vanover, Raleigh, NC (US)

Correspondence Address: Kunzler & McKenzie, 8 EAST BROADWAY, SUITE 600, SALT LAKE CITY, UT, 84111, US

(21) Appl. No.: 11/686,854

(22) Filed: Mar. 15, 2007

(51) Int. Cl. G06Q 40/00

(52) U.S. Cl. 705/37

(57) ABSTRACT

An apparatus, system, and method are disclosed for allocating service requests. A category module categorizes a service request for an information technology support service with a service category. The service request comprises a service requirement. An I/O module communicates the service request to a plurality of providers that are certified to provide the service category and receives bids from the providers. A selection module selects a bid according to a selection policy. A history module may store a history of bid prices and response times.

### BACKGROUND OF THE INVENTION

1. Field of the Invention

This invention relates to allocating requests and more particularly relates to allocating service requests to service providers.

2. Description of the Related Art

Information technology and information technology systems are important to organizations. Besides storing and processing data critical to organizations, information technology systems also handle many organizational transactions and processes.

Because of the importance of information technology, it is vital that information technology users and systems receive timely support when there is a hardware and/or a software problem. For example, if a user is unable to access a critical database, the user may request information technology support service and soon thereafter receive help in accessing the database.

The user's service request may be communicated to an information technology support service provider. The user's organization may have a contract with the information technology support service provider to provide support. The contract may specify a maximum response time. For example, the contract may require the information technology support service provider to respond to a service request within eight (8) hours. In addition, the contract may specify a maximum price for various services. For example, the contract may stipulate that service telephone calls cost no more than twenty-five dollars ($25).

The information technology support service provider may contract the fulfilling of service requests to one or more service providers. As used herein, service providers are referred to as providers. At any time, each provider may utilize a variable portion of the provider's capacity to respond to service requests. As a result each provider may value the opportunity to respond to various service requests differently. For example, at one time a first provider may only be willing to respond to a service request at a maximum contracted cost, while at a second time the first provider may be willing to respond to the service request at a greatly reduced cost.

### SUMMARY OF THE INVENTION

From the foregoing discussion, there is a need for an apparatus, system, and method that allocate service requests. Beneficially, such an apparatus, system, and method would improve service for customers and increase profits for information technology service providers.

The present invention has been developed in response to the present state of the art, and in particular, in response to the problems and needs in the art that have not yet been fully solved by currently available methods for allocating service requests. Accordingly, the present invention has been developed to provide an apparatus, system, and method for allocating service requests that overcome many or all of the above-discussed shortcomings in the art.

The apparatus to allocate service requests is provided with a plurality of modules configured to functionally execute the steps of receiving a service request, categorizing the service request, communicating the service request to qualified providers, receiving bids from the providers, and selecting a bid from the providers. These modules in the described embodiments include an input/output (I/O) module, a category module, and a selection module. The apparatus may also include a history module.

The category module categorizes a service request for an information technology support service with a service category. The service request comprises a service requirement. The I/O module communicates the service request to a plurality of providers that are certified to provide the service category. In addition, the I/O module receives bids from the providers.

The selection module selects a bid according to a selection policy. In one embodiment, the history module stores a history of bid prices and response times. The selection module may select bids that are within a specified range of the history. The apparatus allocates service requests to service providers.

A system of the present invention is also presented to allocate service requests. The system may be embodied in an information technology system that allocates service requests to qualified providers. In particular, the system, in one embodiment, includes a memory module and a processor module.

The memory module stores software instructions and data. The processor module executes the instructions and processes the data. The processor module includes a category module, an I/O module, and a selection module. The processor module may also include a history module.

The category module categorizes a service request for an information technology support service with a service category. The service request comprises a service requirement. The I/O module communicates the service request to a plurality of providers that are certified to provide the service category and receives bids from the providers. The selection module selects a bid according to a selection policy. The history module may store a history of bid prices and response times. The system allocates a service request, selecting options that improve service.

A method of the present invention is also presented for allocating service requests. The method in the disclosed embodiments substantially includes the steps to carry out the functions presented above with respect to the operation of the described apparatus and system. In one embodiment, the method includes receiving a service request, categorizing the service request, communicating the service request to qualified providers, receiving bids from the providers, selecting a bid from the providers. The method also may include storing a history of bid prices and response times.

A category module categorizes a service request for an information technology support service with a service category. The service request comprises a service requirement. An I/O module communicates the service request to a plurality of providers that are certified to provide the service category and receives bids from the providers. A selection module selects a bid according to a selection policy. A history module may store a history of bid prices and response times. The method allocates a service request, selecting options that improve profitability.

References throughout this specification to features, advantages, or similar language do not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention may be practiced without one or more of the specific features or advantages of a particular embodiment. In other instances, additional features and advantages may be recognized in certain embodiments that may not be present in all embodiments of the invention.

The embodiment of the present invention allocates service requests to providers. In addition, the present invention may increase profits while meeting service requirements. These features and advantages of the present invention will become more fully apparent from the following description and appended claims, or may be learned by the practice of the invention as set forth hereinafter.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a schematic block diagram illustrating one embodiment of a computer in accordance with the present invention;

FIG. 2 is a schematic block diagram illustrating one embodiment of an allocation module of the present invention;

FIG. 3 is a schematic flow chart diagram illustrating one embodiment of an allocation method of the present invention;

FIG. 4 is a schematic block diagram illustrating one embodiment of a selection policy of the present invention;

FIG. 5 is a schematic block diagram illustrating one embodiment of price-based bids of the present invention;

FIG. 6 is a schematic block diagram illustrating one embodiment of bids over time of the present invention;

FIG. 7 is a schematic block diagram illustrating one embodiment of a response time-based selection policy of the present invention;

FIG. 8 is a schematic block diagram illustrating one embodiment of a reverse auction selection policy of the present invention; and

FIG. 9 is a schematic block diagram illustrating one embodiment of subsequent bids in a reverse auction of the present invention.

### DETAILED DESCRIPTION OF THE INVENTION

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays (FPGA), programmable array logic, programmable logic devices or the like.

Modules may also be implemented in software for execution by various types of processors. An identified module of executable code may, for instance, comprise one or more physical or logical blocks of computer instructions, which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of executable code may be a single instruction, or many instructions, and may even be distributed over several different code segments, among different programs, and across several memory devices. Similarly, operational data may be identified and illustrated herein within the modules, and may be embodied in any suitable form and organized within any suitable type of data structure. The operational data may be collected as a single data set, or may be distributed over different locations including different storage devices.

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

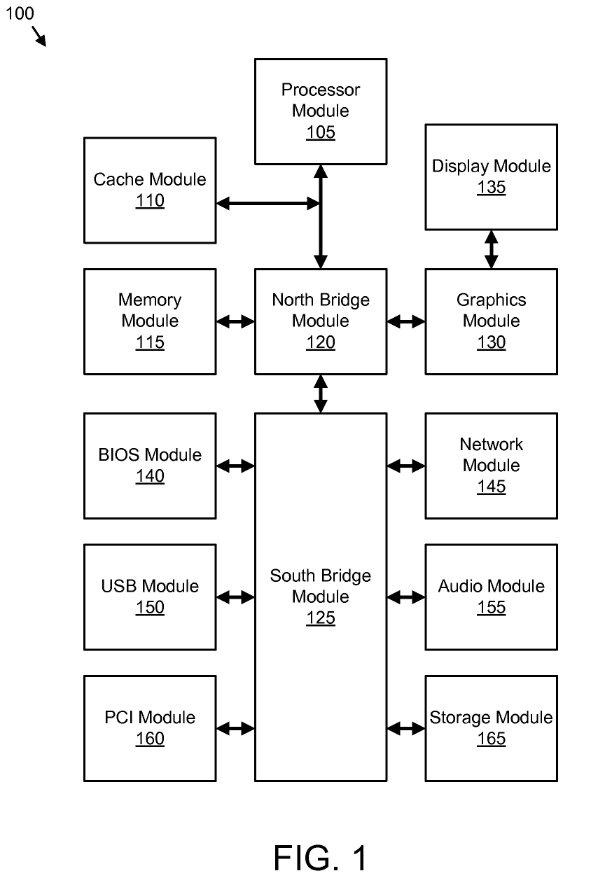

FIG. 1 depicts a schematic block diagram illustrating one embodiment of a computer 100 in accordance with the present invention. The computer 100 has a processor module 105, a cache module 110, a memory module 115, a north bridge module 120, a south bridge module 125, a graphics module 130, a display module 135, a BIOS module 140, a network module 145, a USB module 150, an audio module 155, a PCI module 160, and a storage module 165.

Although for simplicity, one processor module 105, one cache module 110, one memory module 115, one north bridge module 120, one south bridge module 125, one graphics module 130, one display module 135, one BIOS module 140, one network module 145, one USB module 150, one audio module 155, one PCI module 160, and one storage module 165 are shown, any number of processor modules 105, cache modules 110, memory modules 115, north bridge modules 120, south bridge modules 125, graphics modules 130, display modules 135, BIOS modules 140, network modules 145, USB modules 150, audio modules 155, PCI modules 160, and storage modules 165 may be employed.

The processor module 105, cache module 110, memory module 115, north bridge module 120, south bridge module 125, graphics module 130, display module 135, BIOS module 140, network module 145, USB module 150, audio module 155, PCI module 160, and storage module 165, referred to herein as components, may be fabricated of semiconductor gates on one or more semiconductor substrates. Each semiconductor substrate may be packaged in one or more semiconductor devices mounted on circuit cards. Connections between the components may be through semiconductor metal layers, substrate-to-substrate wiring, circuit card traces, and/or wires connecting the semiconductor devices.

The memory module 115 stores software instructions and data. The processor module 105 executes one or more computer program products. The computer program products may be tangibly stored in the storage module 165. The storage module 165 may be a hard disk drive, an optical storage device, a holographic storage device, a micromechanical storage device, a semiconductor storage device, or the like.

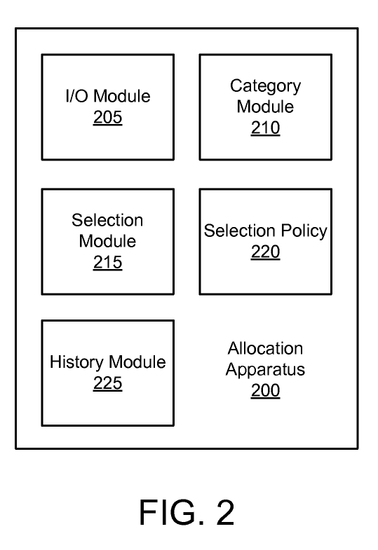

FIG. 2 depicts a schematic block diagram illustrating one embodiment of an allocation apparatus 200 of the present invention. The apparatus 200 allocates service requests and can be embodied in the computer system 100 of FIG. 1. The description of apparatus 200 refers to elements of FIG. 1, like numbers referring to like elements. The apparatus 200 includes an I/O module 205, a category module 210, a selection module 215, a selection policy 220, and a history module 225. The I/O module 205, category module 210, selection module 215, selection policy 220, and history module 225 may comprise one or more computer program products executing on the computer 100.

The I/O module 205 communicates service requests to and receives bids from service providers. For example, the I/O module 205 may request support service bids and receive bids from a plurality of certified providers to correct access availability to a critical database. The service request comprises a service requirement. The service requirement may be a maximum price, a contracted price, and/or a minimum response time.

The category module 210 categorizes service requests for an information technology support service with a service category. For example, the category module 210 may identify that the critical database is written in a computer language that a limited number certified providers support.

The selection module 215 selects a bid received from the certified service providers that satisfies a selection policy 220. The selection policy 220 may be an automatic policy. For example, if the service request requires immediate action, the selection policy 220 may select a certified provider that bids no more than a maximum price. In another example, since the critical database may be serviced by a plurality of certified providers the selection policy 220 may be satisfied with a bid that meets the minimum response time with the lowest price.

In one embodiment, the history module 225 stores a history of bid prices and response times. For example, the history module 225 may store past response time and bid price information that may provide a price/response range for the selection module 215. The selection module 215 may select bids that are within a specified range of the history. The apparatus 200 allocates service requests to service providers.

The schematic flow chart diagram that follows is generally set forth as a logical flow chart diagram. As such, the depicted order and labeled steps are indicative of one embodiment of the presented method. Other steps and methods may be conceived that are equivalent in function, logic, or effect to one or more steps, or portions thereof, of the illustrated method. Additionally, the format and the symbols employed are provided to explain the logical steps of the method and are understood not to limit the scope of the method. Although various arrow types and line types may be employed in the flow chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

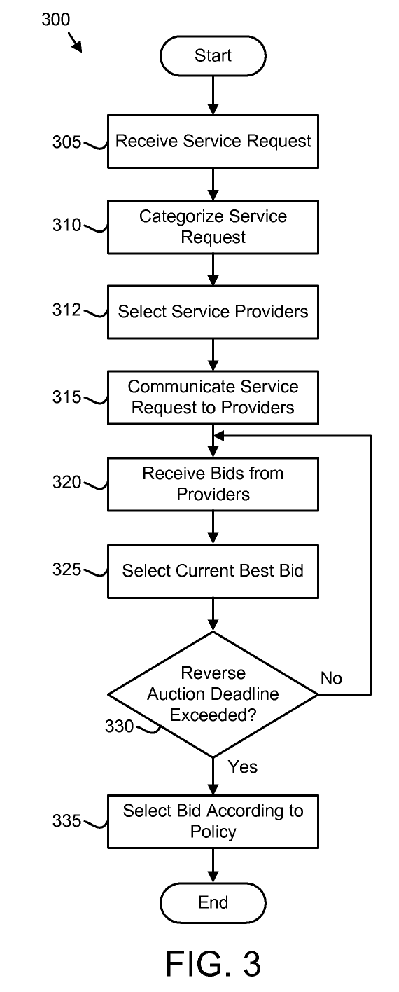

FIG. 3 depicts a schematic flow chart diagram illustrating one embodiment of an allocation method 300 of the present invention. The method 300 substantially includes the steps to carry out the functions presented above with respect to the operation of the described apparatus 200 and system 100 of FIGS. 2 and 1 respectively. The description of method 300 refers to elements of FIGS. 1-2, like numbers referring to like elements. In one embodiment, the method 300 is implemented with a computer program product comprising a computer readable medium having a computer readable program. The computer 100 may execute the computer readable program.

The method 300 begins, and in an embodiment, the I/O module 205 receives 305 the service request. The service request may be communicated as an email from a user, a posting of a one or more data fields to the computer 100, and/or a telephone call to a call center. An attendant may manually enter the service request into a data set of the computer 100. Alternatively, the service request may be automatically received and stored by the computer 100.

In one embodiment, the service request includes a minimum response time service requirement in the range of one hour to twenty-four hours (1 hr-24 hrs). In a certain embodiment, the minimum response time is in the range of six hours to twelve hours (6 hrs-12 hrs). For example, the service I/O module 205 may receive 305 a service request with eight (8) hours as the service requirement minimum response time, indicating that a service provider should respond to the service request within eight (8) hours.

The category module 210 categorizes 310 the service request. For example, the category module 210 may categorize 310 a service request to correct a database that uses ORACLE DATABASE® software produced by Oracle Corporation of San Mateo, Calif. with an “Oracle” category.

In an alternate embodiment, the category module 210 may categorize 310 the service request with one or more preferred service providers. For example, if a client recorded a preference for a group of service providers, the category module 210 may add a category corresponding to the service provider group to the service request.

The selection module 215 selects 312 service providers that provide the required category of service. For example, the selection module 215 may select service providers that have a certification for correcting Oracle-based databases. Service providers without expertise and/or certification for Oracle-based databases may be excluded.

The I/O module 205 communicates 315 the service request to the service providers. For example, the I/O module 205 may notify service providers of the service request to correct the database and request bids based on a response time of eight (8) hours and a maximum price of twenty-five dollars ($25) to provide the service. In another embodiment, the I/O module 205 may notify a single service provider of the need to correct the database based at a contracted price and response time. The I/O module 205 may communicate the service request as an email, a post of data to a service provider server, a post of data to a web site and/or a directory accessible by the service providers, and the like.

The I/O module 205 receives 320 bids from the service providers. In one embodiment, the service providers communicate the bids as Extensible Markup Language (XML) files. The I/O module 205 may parse bid information from the bids. The bid information may include one or more minimum response times, one or more maximum prices, and the like.

In one embodiment, the selection module 215 selects 325 a current best bid. The selection module 215 may select 325 the current best bid for a reverse auction. In a reverse auction, service providers bid against each other to determine who is willing to provide a service at a minimum price. The current best bid may represent a bid that would be selected if a bid is to be selected immediately. For example, the selection module 215 may select 325 a bid from a first provider with a minimum response time of eight (8) hours and a maximum price of eight dollars ($8) as the current best bid for correcting the database. The selection module 215 may employ the selection policy 220 to select 325 the current best bid. The I/O module 205 may communicate the current best bid to the service providers. If there is no reverse auction, the I/O module 205 may not select the current best bid.

In one embodiment, the I/O module 205 determines 330 if a reverse auction deadline is exceeded. For example, the reverse auction deadline may be eight (8) hours. Each provider may submit one or more bids before the end of the reverse auction deadline. The I/O module 205 may determine 330 that the reverse auction deadline is exceeded after eight (8) hours have elapsed. In an alternate embodiment, if there is no reverse auction, the I/O module 205 may determine 330 that the reverse auction deadline is exceeded after a plurality of bids are received 320.

In a certain embodiment, the I/O module 205 determines 330 that the reverse auction deadline is exceeded when a typical service time for the service request as determined by the history module 225 is substantially equivalent to the remaining minimum response time. For example, if on average servicing an Oracle category service request requires one (1) hour and the minimum response time is two (2) hours, the I/O module 205 may determine 330 that the reverse auction deadline is exceeded when the minimum response time ends in one (1) hour.

If the I/O module 205 determines 330 that the reverse auction deadline is not exceeded, the I/O module 205 receives 320 bids from the providers. Continuing the example above, if the I/O module 205 determines 330 that a reverse auction deadline is not exceeded for correcting an Oracle database, the I/O module 205 may receive 320 additional bids from the service providers to correct the database. The additional bids may be in response to the current best bid as will be described hereafter.

If the I/O module 205 determines 330 that the reverse auction deadline is exceeded, the selection module 215 selects 335 the bid according to selection policy 220. For example, if the I/O module 205 determines 330 that the reverse auction deadline is exceeded, the I/O module 205 refuses further bids and the selection module 215 may select 335 a bid with the lowest price from a service provider to correct the Oracle-based database.

The method 300 automates receiving and selecting bids for allocating service requests. The method 300 may employ one or more selection policies 220 to assure that operational criteria such as increasing profit per service request, assuring that service providers can provide service within minimum response times. Selection policies 220 and selection policy criteria will be described hereafter.

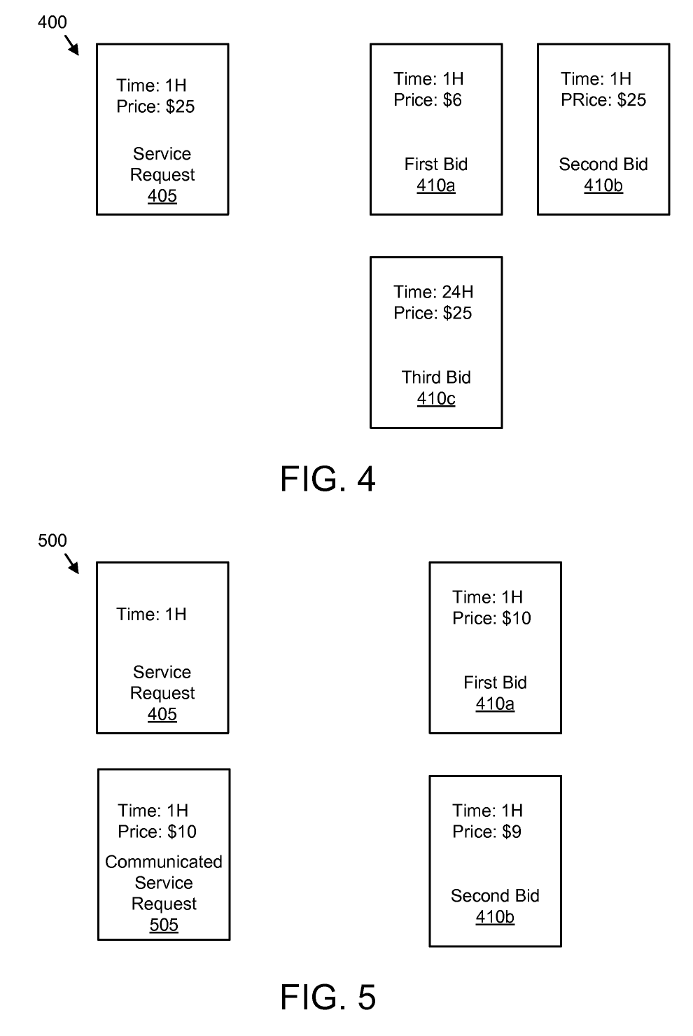

FIG. 4 depicts a schematic block diagram illustrating one embodiment of a selection policy 400 of the present invention. The policy 400 is illustrated with a service request 405, a first bid 410a, a second bid 410b, and a third bid 410c. Although for simplicity the bids 410 from three (3) service providers are shown, any number of bids from any number of certified service providers may be employed. The description of the bids 500 refers to elements of FIGS. 1-4, like numbers referring to like elements. The policy 400 may select a lowest-price bid 410 that meets one or more minimum service requirements.

The I/O module 205 communicates 315 the service request 405 to the service providers. The service providers may be certified to provide the category of service of the service request 405. In the shown embodiment, the service request 405 is for a price of twenty-five dollars ($25) and a response time of one (1) hour. The I/O module 205 may receive 320 the bids 410 in response to the service request 405. The first bid 410a is for a price of six dollars ($6) and a response time of one (1) hour, the second bid 410b is for a price of twenty-five dollars ($25) and a response time of one (1) hour, the third bid 410c is for a price of twenty-five ($25) and a response time of twenty-four (24) hours. The selection policy 220 may select 335 the first bid 410a of six dollars ($6) and response time of one (1) hour based on the price-based selection policy 400 as the first bid 410a meets the minimum service requirement of a one (1) hour minimum response time and has the lowest price.

FIG. 5 depicts a schematic block diagram illustrating one embodiment of price-based bids 500 of the present invention. The bids 500 show the service request 405, first bid 410a, and second bid 410b of FIG. 4. The description of the bids 500 refers to elements of FIGS. 1-4, like numbers referring to like elements.

In the shown embodiment, the service request 405 is for a response time of one (1) hour. Although no price is specified, the I/O module 205 may communicate a communicated service request 505 that specifies a response time of one (1) hour and a price of ten dollars ($10). For example, the history module 225 may record bid prices for the requested service type. The range of prices for the requested service type may be in the range of eight to eleven dollars ($8-11). As a result, the I/O module 205 may select ten dollars ($10) as the price for the communicated service request 505.

In response to the communicated service request 505, the I/O module 205 may receive 320 the first bid 410a for a price of ten dollars ($10) and a response time of one (1) hour and the second bid 410b for a price of nine dollars ($9) and a response time of one (1) hour. The selection module 215 may select 335 the nine dollar ($9) bid based on the selection policy 220 such as the price-base selection policy 400 of FIG. 4.

The communicated service request 505 allows the present invention to modify the service requirements of the original service request 405 that the service providers respond to. For example, the history module 225 may determine that during the hours of 2 a.m. Eastern Standard Time (EST) to 6 a.m. EST that service requests of a particular category can be serviced within one (1) hour for an average price of eight dollars ($8). Therefore the present invention may limit the price of the communicated service request to guide service providers to lower priced bids.

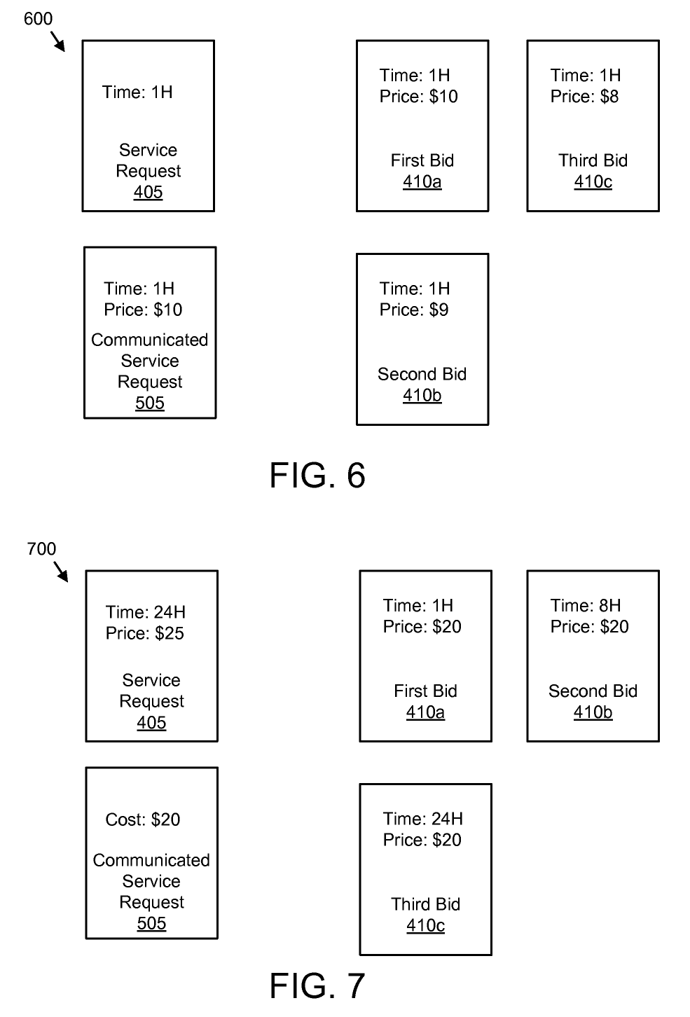

FIG. 6 depicts a schematic block diagram illustrating one embodiment of bids over time 600 of the present invention. The service request 405, communicated service request 505, first bid 410a, and second bid 410b of FIG. 5 are shown along with a third bid 410c. The description of the bids over time 600 refers to elements of FIGS. 1-5, like numbers referring to like elements.

The selection module 215 may delay selecting 335 either the first bid 410a or the second bid 410b illustrated in FIG. 5. In one embodiment, the selection module 215 delays until the I/O module 205 determines 330 that a reverse auction deadline is exceeded. For example, the I/O module 205 may receive bids 410 for a reverse auction period of forty-five (45) minutes. After forty-five (45) minutes, the selection module 215 may select 335 a bid 410.

In an alternate embodiment, the selection module 215 selects 335 a bid 410 at a time that allows the minimum response time to be met. For example, correcting a database may typically require two (2) hours of time to complete. If the minimum response time for a service request 405 is eight (8) hours, the selection module 215 may select 335 a bid 410 within two (2) hours of termination of the minimum response time.

Thus, the I/O module 205 may receive 320 the third bid 410c before the selection module 215 selects 335 a bid 410. The selection module 215 may select 335 the third bid 410c in accordance with the price-based selection policy 400 as the eight dollar ($8) price of the third bid 410c is lower than the prices of the first and second bids 410a, 410b.

FIG. 7 depicts a schematic block diagram illustrating one embodiment of a response time-based selection policy 700 of the present invention. The response time-based selection policy 700 is illustrated with a service request 405, a communicated service request 505, a first bid 410a, a second bid 410b, and a third bid 410c. The description of the policy 700 refers to elements of FIGS. 1-6, like numbers referring to like elements. The policy 700 may select a bid 410 that best satisfies a service requirement at a minimum price.

In the shown embodiment, the service request 405 is for a response time of twenty-four (24) hours and a price of twenty-five dollars ($25). The communicated service request 505 is for a price of twenty dollars ($20). In response to the communicated service request 505, the I/O module 205 receives 320 the first bid 410a for a response time of one (1) hour and a price of twenty dollars ($20), the second bid 410b for a response time of eight (8) hours and a price of twenty dollars ($20), and the third bid 410c for a response time of twenty-four (24) hours and a price of twenty dollars ($20). The policy 700 may direct the selection module 215 to select 335 first bid 410a with the response time of one (1) hour and the price of twenty dollars ($20) as the first bid 410a best meets the service requirement of a twenty-four (24) hour minimum response time at the minimum price of twenty dollars ($20).

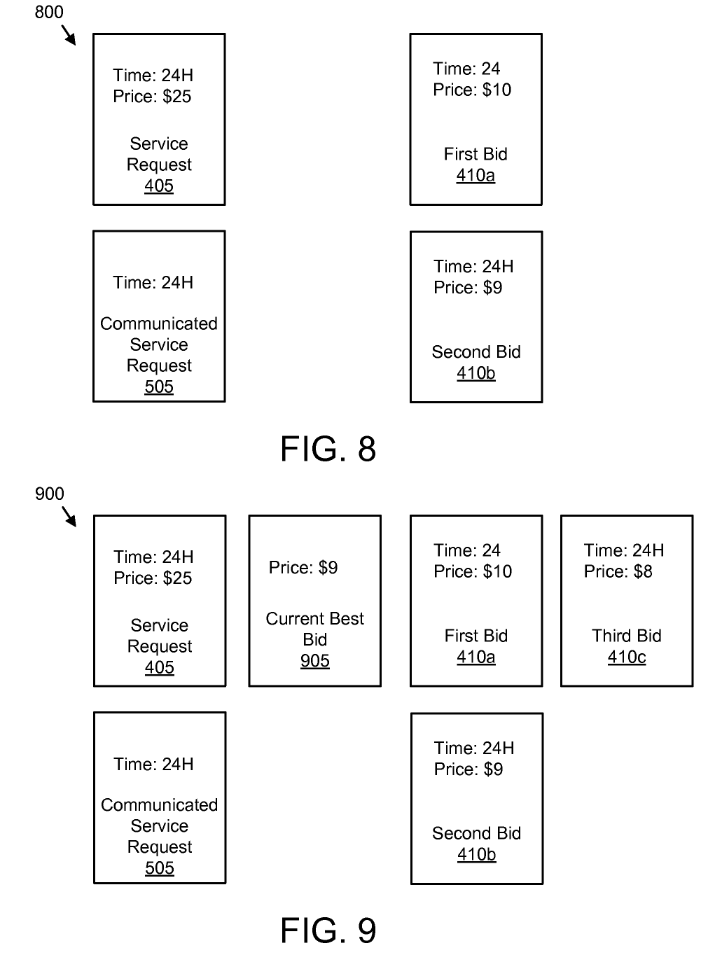

FIG. 8 depicts a schematic block diagram illustrating one embodiment of a reverse auction selection policy 800 of the present invention. The reverse auction selection policy 800 is illustrated with a service request 405, a communicated service request 505, a first bid 410a, and a second bid 410b.

In the shown embodiment, the service request 405 is for a price of twenty-five dollars ($25) and a minimum response time of twenty-four (24) hours. The I/O module 205 communicates 315 the communicated service request 505 for a minimum response time of twenty-four (24) hours to the selected service providers. In response, the I/O module 205 receives 320 the first bid 410a for a price of ten dollars ($10) and a minimum response time of twenty-four (24) hours and the second bid 410b for a price of nine dollars ($9) and a response time of twenty-four (24) hours.

FIG. 9 depicts a schematic block diagram illustrating one embodiment of subsequent bids in a reverse auction 900 of the present invention. The service request 405, communicated service request 505, first bid 410a, and second bid 410b of FIG. 8 are shown. Because a reverse auction time interval is not exceeded, the selection module 215 does not select 335 a bid 410. Instead, the selection module 215 selects 325 a current best bid 905. The current best bid 905 may be selected 325 using the same selection policy 220 that the selection module 215 employs to select 335 a bid 410.

For example, the selection module 215 may employ the price-based selection policy 400 of FIG. 4. As a result, the selection module 215 may select 325 the second bid 410b for the current best bid 905. The current best bid 905 includes the maximum price of nine dollars ($9), indicating that only subsequent bids of less than nine dollars ($9) will be considered. The I/O module 205 may communicate the current best bid 905 to the service providers. In an alternate embodiment, the I/O module 205 only communicates the current best bid 905 to service providers that provide a bid in response to the communicated service request 505.

In response to the current best bid 905, the I/O module 205 may receive 320 a third bid 410c from a service provider for a price of eight dollars ($8) and a response time of twenty-four (24) hours. The third bid 410c may be considered if received 320 before reverse auction deadline is completed. Thus a service provider does not lose an opportunity for servicing a service request 405 if a bid 410 is too high or otherwise unsatisfactory. Instead the service provider may provide subsequent bids 410. Through the current best bid 905, the present invention may guide the service provider to the price, minimum response time, and other criteria that would allow the service provider's bid 410 to be selected.

The embodiment of the present invention allocates service requests 405 to service providers. In addition, the present invention may increase profits while meeting service requirements.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An apparatus for allocating service requests, the apparatus comprising:
a category module configured to categorize a service request for an information technology support service with a service category, wherein the service request comprises a service requirement;
an input/output (I/O) module configured to communicate the service request to a plurality of providers that are certified to provide the service category and receive bids from the providers; and
a selection module configured to select a bid according to a selection policy.

2. The apparatus of claim 1, wherein the service requirement is selected from a maximum price, a contracted price, and a minimum response time.

3. The apparatus of claim 2, wherein the selection policy is configured to maximize profit while meeting the minimum response time.

4. The apparatus of claim 1, wherein the selection policy comprises a reverse auction deadline, the selection module is further configured to select a current best bid, the I/O module communicates the current best bid to the providers and receives additional bids, and the selection module selects the bid when the reverse auction deadline is exceeded.

5. The apparatus of claim 1, the apparatus further comprising a history module configured to store a history of bid prices and response times and wherein the selection module selects bids that are within a specified range of the history.

6. A computer program product comprising a computer useable medium having a computer readable program, wherein the computer readable program when executed on a computer causes the computer to:
categorize a service request for an information technology support service with a service category, wherein the service request comprises a service requirement;
communicate the service request to a plurality of providers that are certified to provide the service category;
receive bids from the providers; and
select a bid according to a selection policy.

7. The computer program product of claim 6, wherein the service requirement is configured as a maximum price.

8. The computer program product of claim 7, wherein the maximum price is configured as a contracted price.

9. The computer program product of claim 7, wherein the selection policy is configured to not exceed the maximum price.

10. The computer program product of claim 6, wherein the service requirement is configured as a minimum response time.

11. The computer program product of claim 10, wherein the selection policy is configured to maximize profit while meeting the minimum response time.

12. The computer program of claim 11, wherein the computer readable code is further configured to cause the computer to select a current best bid and communicate the current best bid to the providers and the selection policy comprises a reverse auction deadline wherein the computer selects the bid when the reverse auction deadline is exceeded.

13. The computer program product of claim 6, wherein the computer readable code is further configured to cause the computer to store a history of bid prices and response times and select bids that are within a specified range of the history.

14. The computer program product of claim 6, wherein the computer readable code is further configured to cause the computer to receive a plurality of bids from each provider.

15. The computer program product of claim 6, wherein the computer readable code is further configured to allow a user to select from a plurality of response time and price combinations.

16. A system for allocating service requests, the system comprising:
a memory module configured to store software instructions and data;
a processor module configured to execute the software instructions and process the data and comprising
a category module configured to categorize a service request for an information technology support service with a service category, wherein the service request comprises a service requirement selected from a maximum price, a contracted price, and a minimum response time;
an I/O module configured to communicate the service request to a plurality of providers that are certified to provide the service category and receive bids from the providers; and
a selection module configured to select a bid according to a selection policy.

17. The system of claim 16, wherein the selection policy is configured to maximize profit while meeting the minimum response time.

18. The system of claim 16, wherein the selection policy comprises a reverse auction deadline, the selection module is further configured to select a current best bid, the I/O module communicates the current best bid to the providers, and selection module selects the bid when the reverse auction deadline is exceeded.

19. The system of claim 16, the processor module further comprising a history module configured to store a history of bid prices and response times and wherein the selection module selects bids that are within a specified range of the history.

20. A method for deploying computer infrastructure, comprising integrating computer readable code into a computing system, wherein the code in combination with the computing system is capable of performing the following:
selecting a reverse auction deadline;
categorizing a service request for an information technology support service with a service category, wherein the service request comprises a service requirement;
communicating the service request to a plurality of providers that are certified to provide the service category;
receiving bids from the providers;
selecting a current best bid;
communicating the current bid to the providers;
receiving additional bids from providers in response to the current best bid; and
selecting a bid according to a selection policy when the reverse auction deadline is exceeded.
